(19) United States
(12) Patent Application Publication
(10) Pub. No.: US 2017/0045355 A1
(43) Pub. Date: Feb. 16, 2017

(54) SCATTERING MEASUREMENT SYSTEM AND METHOD

(71) Applicant: Industrial Technology Research Institute, Chutung Chen (TW)

(72) Inventors: Yi-Chen HSIEH, Chutung (TW); Chia-Liang YEH, Chutung (TW); Chia-Hung CHO, Chutung (TW); Yi-Chang CHEN, Chutung (TW); Yi-Sha KU, Chutung (TW); Chun-Wei LO, Chutung (TW)

(21) Appl. No.: 14/974,892

(22) Filed: Dec. 18, 2015

(30) Foreign Application Priority Data
Aug. 12, 2015 (TW) 104126218

(51) Int. Cl. G01B 11/24

(52) U.S. Cl. CPC G01B 11/24

(57) ABSTRACT

A scattering measurement system is provided, including: a light source generator for generating a detection light beam with multi-wavelengths, wherein the detection light beam is incident on an object so as to generate a plurality of multi-order diffraction light beams with three-dimensional feature information; a spatial filter for filtering out zero-order light beams from the plurality of multi-order diffraction light beams; and a detector having a photosensitive array for receiving the plurality of multi-order diffraction light beams filtered out by the spatial filter and converting the filtered plurality of multi-order diffraction light beams into multi-order diffraction signals with the three-dimensional feature information. As such, the three-dimensional structure of the object can be obtained by comparing the multi-order diffraction signals with a database.

### CROSS-REFERENCE TO RELATED APPLICATION

This application claims the benefit of Taiwan Application Serial No. 104126218, filed on Aug. 12, 2015. The entirety of the above-mentioned patent application is hereby incorporated by reference herein and made a part of this specification.

### TECHNICAL FIELD

The technical field relates to a scattering measurement system and method for measuring a three-dimensional structure.

### BACKGROUND

It is described in the 2013 edition of ITRS (International Technology Roadmap for Semiconductors) Metrology Summary that FinFETs are now the dominant key element architecture of advanced microprocessors and both FinFETs and other three-dimensional structure measurement technologies are facing the challenges of reduced size and increased aspect ratio.

Current nanoscale measurement instruments such as CD-SEMs and CD-AFMs only provide a two-dimensional (X-axis and Y-axis) measurement of a surface structure, which are limited in providing a third dimensional (Z-axis) measurement. Therefore, dimensions such as the line width, the height and the sidewall angle of a three-dimensional structure having a high aspect ratio cannot be obtained. To overcome the drawback, a measurement method is proposed. A conventional measurement method involves emitting a light beam from a light source generator onto an object through a light focusing element. Then, the light beam passes through a lens and is collected by a camera. With the rotation of a prism, the incident angle of the light beam incident on the object is changed. The light beam is scattered and dispersed by the object to generate multi-order diffraction signals, and zero-order signals of the multi-order diffraction signals are measured. Based on the correlation between the zero-order signals and the incident angles, a feature spectrum is generated to facilitate analysis of the three-dimensional structure of the object. However, in the above-described measurement method, an error of the rotating mechanism appears in the measurement result. In addition, the measurement process is time-consuming. According to another conventional measurement method, a light beam from a broadband light source is incident on an object with a fixed angle. The light beam is then scattered by the object to generate multi-order diffraction signals. Zero-order signals of the multi-order diffraction signals are captured and then dispersed by a spectrometer. As such, the distribution of diffraction intensities at different wavelengths is measured to facilitate analysis of the three-dimensional structure of the object. However, after the light passes through a dispersive element and a slit of the spectrometer, the light intensity decays significantly that adversely affects the measurement accuracy. Therefore, in the above-described measurement methods, the measurement accuracy is reduced either by an error of the rotating mechanism or by a significant decay of the light intensity after the light passes through a dispersive element.

Therefore, if the three-dimensional structure of an object (including the Z-axis dimension) can be quickly and accurately measured based on a theoretical model of a laser light scattering device and hardware experiences with the laser light scattering device as well as EUV (extreme ultraviolet) scattering device technologies, measurement of future nanoscale objects will be facilitated. It has become urgent to solve this issue.

### SUMMARY

An embodiment of the disclosure relates to a scattering measurement system, which comprises: a light source generator configured to generate a detection light beam with multi-wavelengths, wherein the detection light beam is incident on an object so as to generate a plurality of multi-order diffraction light beams with three-dimensional feature information; a spatial filter configured to filter out zero-order light beams from the plurality of multi-order diffraction light beams; and a detector having a photosensitive array and configured to receive the plurality of multi-order diffraction light beams filtered out by the spatial filter and convert the plurality of filtered multi-order diffraction light beams into multi-order diffraction signals with the three-dimensional feature information.

According to one embodiment, the scattering measurement system of the present disclosure further comprises a comparison unit configured to compare the multi-order diffraction signals with a plurality of multi-order diffraction feature patterns of a database so as to obtain a three-dimensional structure of the object corresponding to the multi-order diffraction signals.

According to one embodiment, the present disclosure further provides a scattering measurement method, which comprises the steps of: emitting a detection light beam with multi-wavelengths onto an object so as to generate a plurality of multi-order diffraction light beams with three-dimensional feature information; filtering out, by a spatial filter, zero-order light beams from the plurality of multi-order diffraction light beams; receiving, by a photosensitive array, the plurality of multi-order diffraction light beams with the zero-order light beams filtered out; and converting the received plurality of multi-order diffraction light beams into multi-order diffraction signals with the three-dimensional feature information.

According to another embodiment, a light beam with multi-wavelengths (for example, a light beam with discontinuous multi-wavelengths) is incident on an object and scattered by the object to generate a plurality of multi-order diffraction light beams. A movable spatial filter is used to filter out zero-order light beams from the plurality of multi-order diffraction light beams and the filtered plurality of multi-order diffraction light beams are converted into multi-order diffraction signals with three-dimensional feature information of the object. Further, a three-dimensional structure of the object is obtained by comparing the multi-order diffraction signals with a database.

The foregoing will become better understood from a careful reading of a detailed description provided herein below with appropriate reference to the accompanying drawings.

### BRIEF DESCRIPTION OF DRAWINGS

FIG. 1 is a schematic diagram of a scattering measurement system according to the present disclosure;

FIG. 2 is a schematic diagram of the scattering theory according to an exemplary embodiment of the disclosure;

FIGS. 3A and 3B are a pair of graphs showing distribution of zero-order signals and 1st-order signals of different wavelengths according to an exemplary embodiment of the disclosure;

FIGS. 4A and 4B are two schematic diagrams showing operation of the scattering measurement system according to an exemplary embodiment of the disclosure;

FIGS. 5A to 5E are schematic diagrams showing reconstruction of the three-dimensional structure of an object according to an exemplary embodiment of the disclosure; and

FIG. 6 is a schematic flow diagram showing a scattering measurement method according to an exemplary embodiment of the disclosure.

### DETAILED DESCRIPTION

The following illustrative embodiments are provided to illustrate the present disclosure. These and other advantages and effects can be apparent to those in the art after reading this specification. It should be noted that all the drawings are not intended to limit the present disclosure. Various modifications and variations can be made without departing from the spirit of the present disclosure.

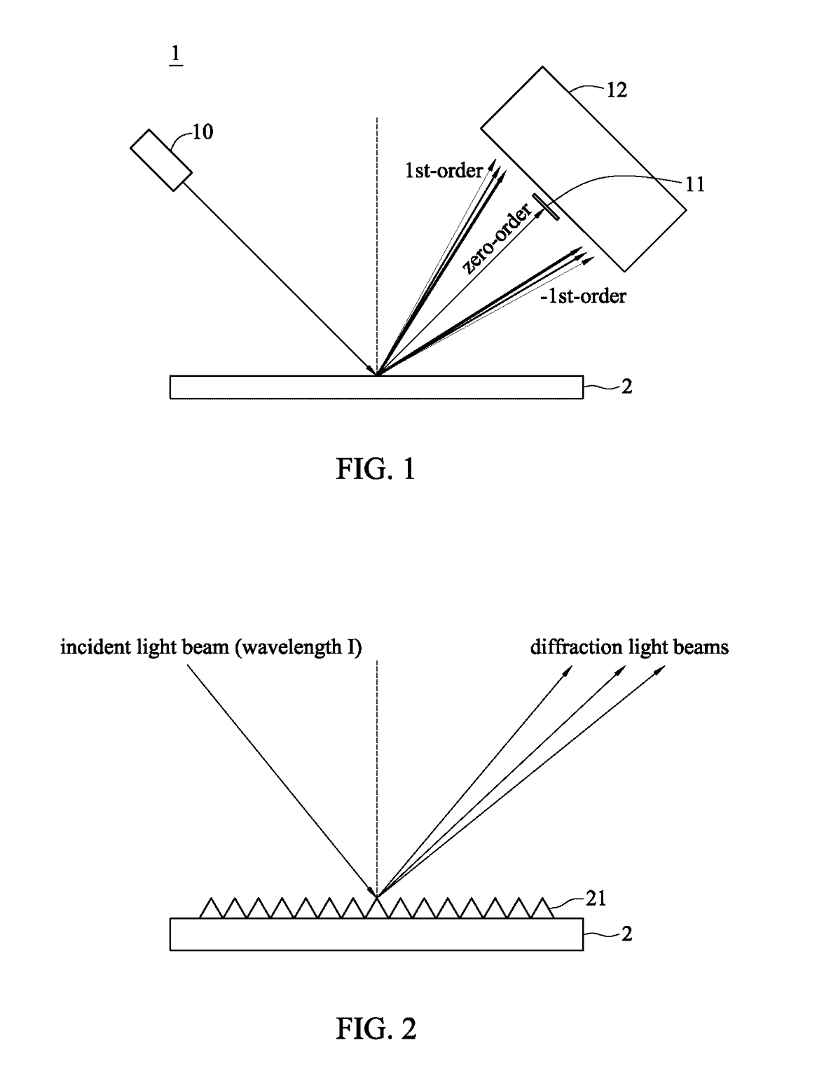

FIG. 1 is a schematic diagram of a scattering measurement system according to an exemplary embodiment of the disclosure. FIG. 1 shows the operation principle of the scattering measurement system. Referring to FIG. 1, the scattering measurement system 1 includes a light source generator 10, a spatial filter 11 and a detector 12.

The light source generator 10 generates a detection light beam with multi-wavelengths. The detection light beam is incident on an object 2 so as to generate a plurality of multi-order diffraction light beams with three-dimensional feature information. In practice, the wavelength band of the detection light beam generated by the light source generator 10 can be determined according to the dimension of the object 2. For example, if the object is a FinFET having a nanoscale dimension, the light source generator 10 can be a light projecting device projecting a light source having multi-wavelengths within a narrow band, including an EUV (extreme ultraviolet) band.

In an embodiment, the multi-wavelengths of the detection light beam are discontinuous. In one embodiment, the present disclosure uses an HHG (High-order Harmonic Generation) EUV light beam with discontinuous multi-wavelengths. The HHG EUV light beam is incident on the object 2 through a focusing mirror.

The spatial filter 11 is used to filter out zero-order diffraction light beams from the multi-order diffraction light beams, which are scattered by the object 2. In one embodiment, the spatial filter 11 has a low transmission filter for filtering out the zero-order diffraction light beams. By filtering out the zero-order diffraction light beams from the multi-order diffraction light beams, the present disclosure uses the multi-order diffraction light beams with the zero-order diffraction light beams filtered out for subsequent analysis, instead of using the zero-order diffraction light beams as in the prior art. Further, the position of the zero-order diffraction light beams can be calculated according to the scattering law.

Generally, since the signal intensity of the zero-order diffraction light beams is greater than the signal intensity of the other non-zero order diffraction light beams, the conventional methods use the zero-order diffraction light beam signals for analysis and the other non-zero order diffraction light beam signals are regarded as noises. The conventional methods can be used to measure large-scale objects by measuring zero-order signals at a plurality of angles using a single wavelength beam or measuring zero-order signals using a multi-wavelengths beam, and generating 1st-order signals at a fixed position through an optical element for subsequent analysis. However, since the zero-order signals do not have sufficient sensitivity for small-scale objects such as FinFETs, the above-described methods cannot be applied in measuring small-scale objects.

The present disclosure is used to measure small-scale objects. The present disclosure filters out the zero-order diffraction light beams and uses the multi-wavelength multi-order diffraction light beams without the zero-order diffraction light beams, for example, 1st-order light beams (i.e., 1st-order and/or −1st-order light beams as shown in FIG. 1) for analysis. The reason is described as follows. Firstly, since the intensity of the zero-order light beams is greater than the intensity of the non-zero order light beams, if the detector receives only the zero-order light beams, the detector would become over-saturated that adversely affects the analysis accuracy. Secondly, after the detection light beam is scattered by the object, the non-zero order (e.g., the 1st-order) diffraction light beams also include the three-dimensional structure information of the object. In an embodiment, for a small-scale object, e.g., a nanoscale or smaller object, the 1st-order diffraction light beam signals with multi-wavelengths are sufficient to be detected by the detector, and therefore the zero-order diffraction light beams are not needed. In addition, the conventional light dispersion process can be omitted so as to simplify the scattering measurement process and architecture.

The detector 12 has a photosensitive array for receiving the plurality of multi-order diffraction light beams filtered out by the spatial filter 11 and converting the filtered multi-order diffraction light beams into multi-order diffraction signals with the three-dimensional feature information. The photosensitive array of the detector 12 is, for example, a CCD or CMOS array. The detector 12 receives the multi-order diffraction light beams filtered out by the spatial filter 11. At this point, the multi-order diffraction light beams do not include any zero-order light beams. The multi-order diffraction light beams (i.e., multi-wavelength non-zero order diffraction light beams) received by the detector 12 do not need to be dispersed as in the prior art. The detector 12 can convert the multi-order diffraction light beams with the three-dimensional feature information into multi-order diffraction signals with the three-dimensional feature information.

Therefore, the scattering measurement system of the present disclosure can be used to measure a small-scale object, e.g., a nanoscale object. By filtering out multi-wavelength zero-order diffraction light beams and capturing multi-wavelength multi-order diffraction light beams, the present disclosure obtains the three-dimensional feature information of the object. As compared with the prior art, the present disclosure simplifies the measurement process and is capable of quickly obtaining the three-dimensional structure of the object with high resolution.

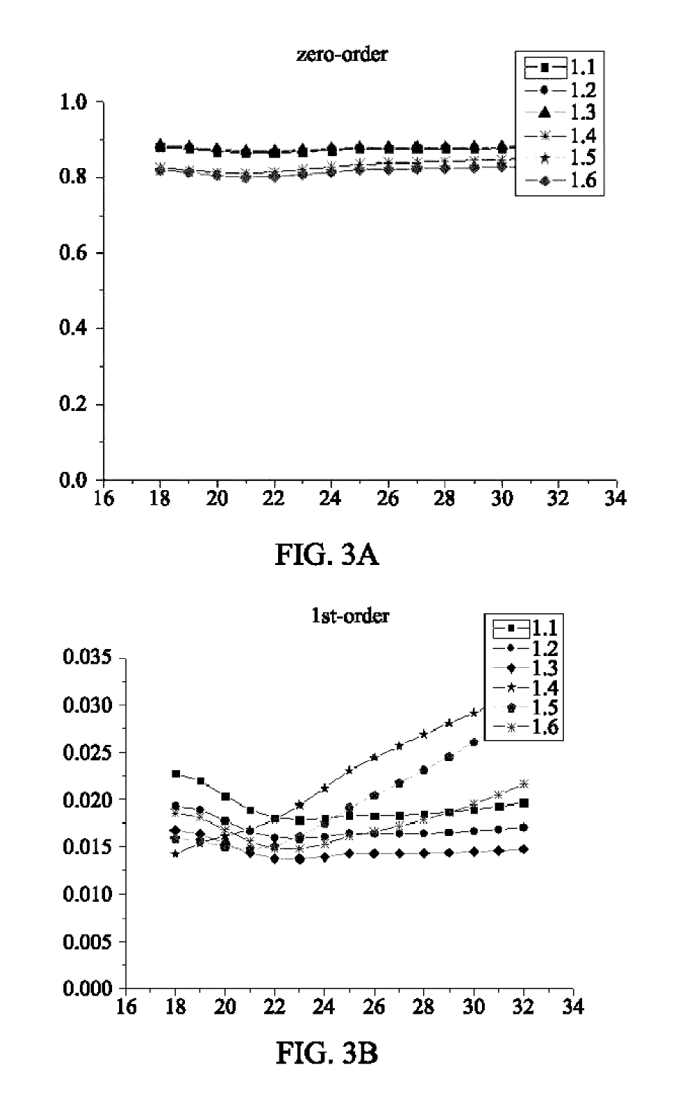

FIG. 2 is a schematic diagram showing the scattering theory according to an embodiment of the present disclosure. According to the scattering theory, when a light beam is incident on the object 2, the intensity and position of the scattered light are dependent on the incident angle or wavelength of the light beam, thereby generating a feature pattern. For example, when the object 2 having a periodically arranged grating structure 21 is irradiated by a light source, its scattering pattern is closely correlated with the grating structure. By analyzing the scattering pattern, the shape and structure parameters of the diffraction grating can be obtained.

Based on Maxwell's equations, the scattering pattern can be accurately converted into the average features of the isometric grating, such as the CD (critical dimension), the sidewall angle, the film thickness and so on. Currently, there are two kinds of architectures used for scattering devices in semiconductor process measurement: a multi-angle scattering device architecture using a single-wavelength laser light incident at a plurality of angles, and an ellipsometer or reflectometer architecture using a multi-wavelength light source incident at a single angle.

Further, the present disclosure enables a light beam with discontinuous multi-wavelengths to be incident on an object to thereby collect multi-order scattering signals. When light is scattered by a periodic structure to generate light beams with a plurality of diffraction orders, the diffraction light beams are distributed at different angles in space according to the grating equation, which is shown as the following equation 1:

sinqi+sinqn=nλ/d equation 1,

wherein qi represents an incident angle, qn represents a distribution angle of an n^{th}-order diffraction light beam in the space, λ represents the wavelength of an incident light beam, and d represents the periodic size of the grating structure. Based on the diffraction theory, changes of the scattering pattern caused by variations of structure parameters can be calculated. A software model is established based on the theory for analyzing and comparing the pattern so as to provide data of the structure.

In principle, since the interaction between the incident light beam and the periodic grating structure is quite complicated, the energy of the incident light beam diffracted to different diffraction orders in space is quite sensitive to the size of the periodic grating structure, such that the feature of the grating structure can be measured.

Therefore, the present disclosure enables a light beam with discontinuous multi-wavelengths to be incident on the object 2 to generate multi-order diffraction signals. Zero-order signals are filtered out from the multi-order diffraction signals by the spatial filter, and the multi-wavelength non-zero order diffraction signals are received by the detector.

To obtain the three-dimensional structure of the object, the scattering measurement system of the present disclosure further has a comparison unit (not shown) disposed in an electronic device (such as a computer, a server, and the like) connected/coupled to the detector 12 of FIG. 1. The comparison unit is used to compare the multi-order diffraction signals with multi-order diffraction feature patterns in a database so as to obtain a three-dimensional structure of the object corresponding to the multi-order diffraction signals. The multi-order diffraction signals refer to the multi-order diffraction signals with zero-order signals filtered out by the spatial filter. The comparison unit may be implemented in a form of software, firmware or hardware by employing a general programming language (e.g., C or C+ ), a hardware description language (e.g., Verilog HDL or VHDL) or other suitable programming languages. The software (or firmware) capable of executing the functions may be deployed in an electronic device accessible media, such as magnetic tapes, semiconductor memories, magnetic disks or compact disks (e.g., CD-ROM or DVD-ROM) or may be delivered through the Internet, wired communication, wireless communication or other communication media. The software (or firmware) may be stored in the electronic device accessible media for a processor of the electronic device to access/execute the programming codes of the software (or firmware). Moreover, the apparatus and method provided in the disclosure may be implemented by combination of hardware and software.

In one embodiment, the multi-order diffraction feature patterns are multi-wavelength multi-order diffraction feature patterns that are established based on a rigorous coupled-wave theory.

To remove a measurement error caused by instability of the light source, any two multi-order signals having a same wavelength are divided by one another. Because of the correlation between the light wavelengths and the dimension of the object, the light wavelengths at nanoscale are quite short, which results in poor stability of the light. Therefore, based on the proportional relationship between multi-orders at each wavelength, the present disclosure reduces the measurement error caused by instability of the light source.

For example, the light intensities of the 1st-order signals λ₁, λ₂, and λ₃ are 0.5, 0.6, and 0.7, respectively, and the light intensities of the 2nd-order signals λ₁, λ₂, and λ₃ are 0.6, 0.7, and 0.8, respectively. If the light source changes, the light intensities of the 1st-order signals λ₁, λ₂, and λ₃ are 0.6, 0.7, and 0.8, respectively, and the light intensities of the 2nd-order signals λ₁, λ₂, and λ₃ are 0.7, 0.8, and 0.9, respectively. As such, any two of the multi-order signals are divided by one another to determine whether the light source is stable. That is to say, if a measurement error occurs, it can be determined whether it is caused by instability of the light source.

According to the prior art, only the zero-order light beam signals are captured, and only one set of light intensity data can be obtained each time. Even if another set of light intensity data is obtained later, it cannot be determined whether the light source is stable due to the lack of a comparison basis.

Therefore, the use of multi-order signals facilitates to remove the measurement error caused by instability of the light source.

Further, a database is established based on a rigorous coupled-wave theory to compare the signals with feature patterns so as to analyze the three-dimensional structure of the object or obtain the structure of the object in an inverse way according to the diffraction theory. Through computerized operation, a comparison database can be established by collecting a lot of diffraction patterns formed through variations of various kinds of parameters. After being established, the comparison database can be used for analysis and comparison. That is to say, after obtaining scattering data, the measurement system compares the scattering data with the data of the database so as to find the closest model data.

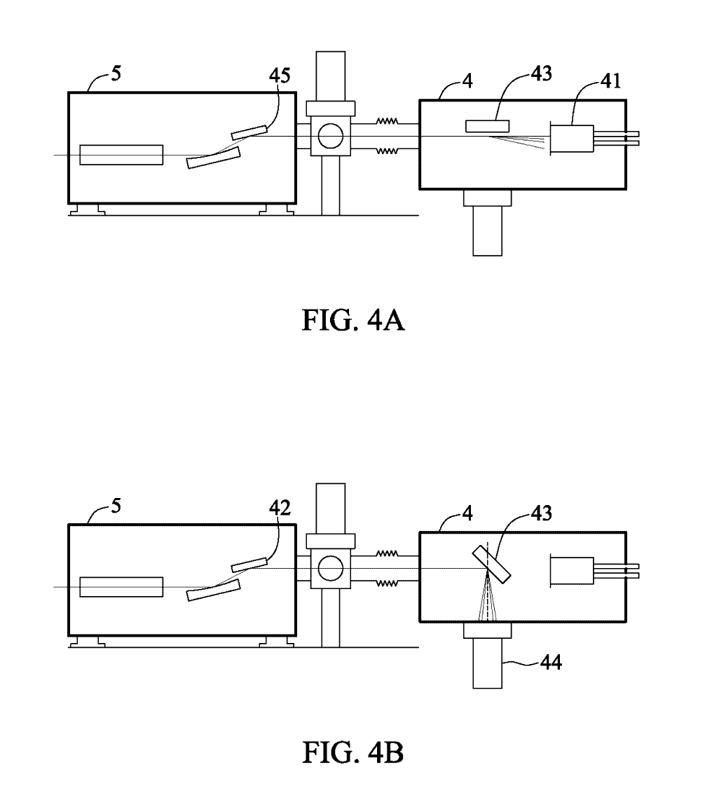

FIGS. 3A and 3B are two graphs showing distribution of zero-order signals and 1st-order signals of different wavelengths according to an embodiment of the present disclosure. Referring to FIG. 3A, an object having a grating periodic pitch of about 50 nm is measured, and the relationship between the light wavelength and intensity of multi-wavelength zero-order signals is shown. Referring to FIG. 3A, the light intensities of the zero-order signals of different wavelengths (from 1.1 to 1.6) cannot be clearly differentiated, which increases the subsequent analysis difficulty.

FIG. 3B shows the relationship between the light wavelength and intensity of non-zero order signals with multi-wavelengths. It is noted that the 1st-order signals are exemplified. Referring to FIG. 3B, the light intensities of the 1st-order signals of different wavelengths (from 1.1 to 1.6) can be clearly differentiated, which facilitates the subsequent analysis.

Therefore, using multi-wavelength non-zero order signals is advantageous in measuring small-sized structures.

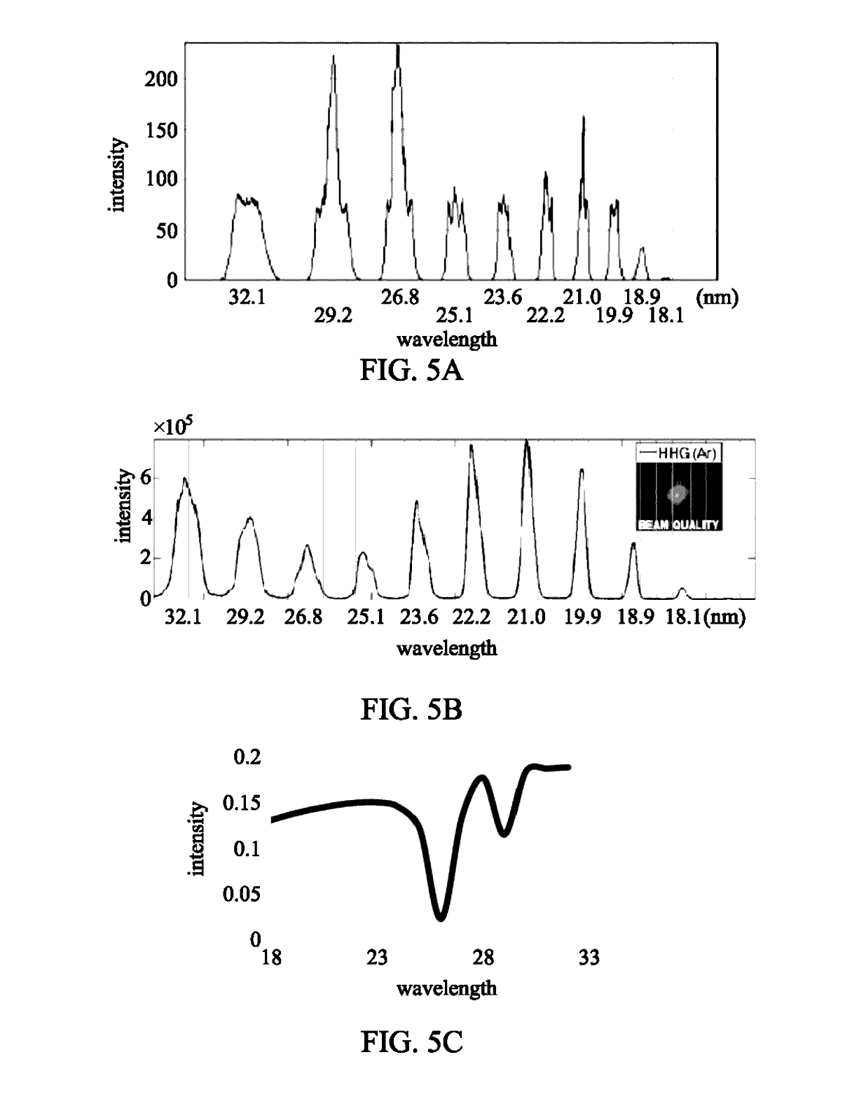

FIGS. 4A and 4B are two schematic diagrams showing operation of the scattering measurement system according to an embodiment of the present disclosure. Referring to FIGS. 4A and 4B, a light source generator 5 provides a detection light beam. The light source generator 5 can be a spectrometer, e.g., a Hettrick Scientific soft X-ray spectrometer. A measurement device 4 includes a first set of photosensitive devices 41 and a second set of photosensitive devices 44.

FIG. 4A shows operation for determining whether the light source is normal or stable. Whether the light source is normal can be determined through a comparison between current and previous data, and whether the light source is stable can be observed in a time period. During the process, the detection light beam is scattered by the grating 45 of the light source generator 5. The object 43 does not affect the transmission of the light beam. In one embodiment, the light beam from the light source generator 5 directly enters the measurement device 4, and is received by the first set of photosensitive devices 41, such that the light source instead of the object 43 is measured during this process.

As shown in FIG. 4B, the object 43 is rotated by an angle of about 45 degree. The grating 45 of the light source generator 5 is replaced by a reflective element 42. The light beam is reflected by the reflective element 42, entering the measurement device 4 and diffracted by the object 43 so as to generate diffraction light beams. The diffraction light beams are received by the second set of photosensitive devices 44.

Therefore, after the light source is measured and determined as stable, the orientation of the object 43 is changed by an angle so as to be measured. In one example, the second set of photosensitive devices 44 receives the diffraction light beams for analysis and comparison. The comparison refers to a comparison between the diffraction light beam signals and feature patterns of the above-described database.

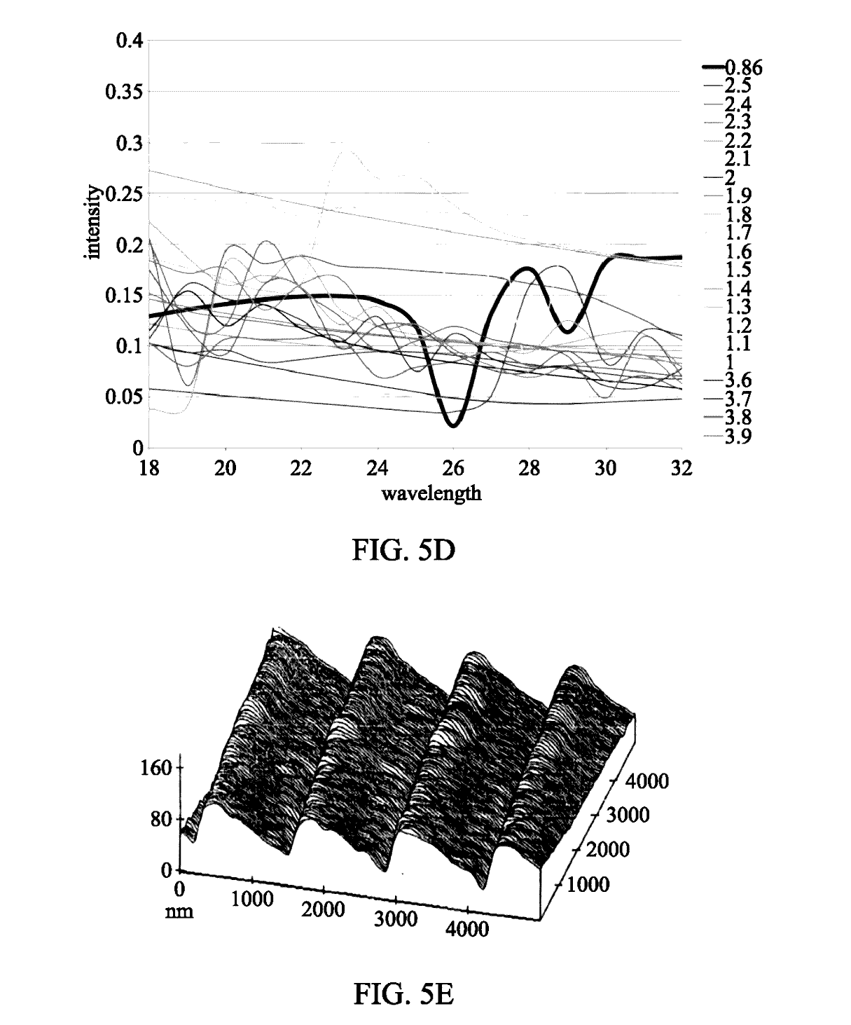

FIGS. 5A to 5E are schematic diagrams showing detailed operation of the scattering measurement system according to an embodiment of the present disclosure. FIG. 5A represents the measurement result of the second set of photosensitive devices 44 of FIG. 4B, i.e., the multi-wavelength non-zero order (e.g., the 1st-order) diffraction light beams diffracted by the object 43, which are defined as I.

FIG. 5B shows the measurement result of the first set of photosensitive devices 41 of FIG. 4A, i.e., the multi-wavelength light source that does not pass through the object 43 but is only diffracted by the grating 45, which is defined as I₀.

FIG. 5C shows feature pattern signals of the object 43 generated by dividing the multi-order diffraction light beams I with the multi-wavelength light source I₀. It should be noted that both FIG. 5A and FIG. 5B have nine discontinuous wavelengths. After the division operation, there should be 9 points in FIG. 5C. However, for the purpose of easy understanding, the points are connected into a continuous curve.

FIG. 5D shows a comparison database with a plurality of multi-order diffraction feature patterns pre-stored therein, i.e., three-dimensional feature signals obtained after a multi-wavelength light beam is diffracted by an object. The feature signals of the object 43 of FIG. 5A is compared with the database of FIG. 5B to find the matching one. Accordingly, the three-dimensional structure of the object is obtained, as shown in FIG. 5E.

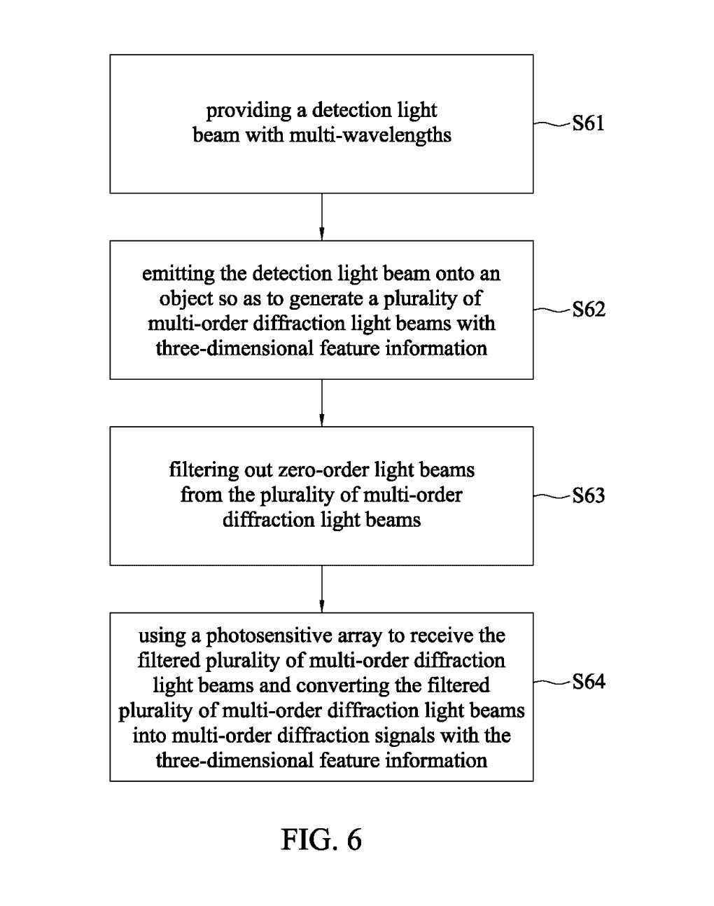

FIG. 6 is a schematic flow diagram showing a scattering measurement method according to an embodiment of the present disclosure. The scattering measurement method involves emitting a multi-wavelength detection light beam onto an object to be measure so as to generate a plurality of multi-order diffraction light beams with three-dimensional feature information. Then, a photosensitive array receives the plurality of multi-order diffraction light beams with zero-order light beams filtered out, and converts the received plurality of multi-order diffraction light beams into multi-order diffraction signals with the three-dimensional feature information. The process is detailed as follows.

At step S61, a multi-wavelength detection light beam is provided. In practice, the multi-wavelength detection light beam is a detection light beam with discontinuous wavelengths, e.g., an HHG EUV light beam with discontinuous multi-wavelengths.

At step S62, the multi-wavelength light beam is incident on an object, thereby generating a plurality of multi-order diffraction light beams with three-dimensional feature information. In one example, after the detection light beam is incident on the object, the incident light is scattered by the object so as to generate a plurality of light beams with multiple diffraction orders. The scattered light beams include three-dimensional feature information of the object which refers to as multi-order diffraction light beams with three-dimensional feature information.

At step S63, zero-order light beams are filtered out from the plurality of multi-order diffraction light beams. At this step, a low transmission filter is used to filter out the zero-order light beams. Instead of using the zero-order light beams, the present disclosure uses the non-zero order light beams, e.g., the 1st-order diffraction light beams, for subsequent analysis. As described above, using non-zero order signals is advantageous in measuring small-sized structures.

At step S64, a photosensitive array is used to receive the plurality of multi-order diffraction light beams with the zero-order light beams filtered out and convert the filtered plurality of multi-order diffraction light beams into multi-order diffraction signals with the three-dimensional feature information. The photosensitive array can be, for example, a CCD array. The diffraction light beams with the zero-order light beams filtered out do not need to be dispersed as in the prior art. The photosensitive array receives the diffraction light beams with the zero-order light beams filtered out and converts the filtered diffraction light beams into multi-order diffraction signals with the three-dimensional feature information for subsequent analysis or comparison, thereby reconstructing the three-dimensional structure of the object.

The scattering measurement method of the present disclosure further includes comparing the multi-order diffraction signals with a plurality of preset multi-order diffraction feature patterns so as to obtain a three-dimensional structure of the object corresponding to the multi-order diffraction signals. In one example, after the multi-order diffraction signals are obtained, they are compared with a pre-established comparison database. The comparison database has multi-order diffraction feature patterns of different multi-wavelengths that are established based on a rigorous coupled-wave theory. Through such a comparison, the three-dimensional structure of the object can be obtained.

According to the scattering measurement system and method of the present disclosure, a light beam with multi-wavelengths is incident on an object and scattered by the object to generate a plurality of multi-order diffraction light beams. A spatial filter is used to filter out zero-order light beams from the plurality of multi-order diffraction light beams and the filtered plurality of multi-order diffraction light beams are converted into multi-order diffraction signals with three-dimensional feature information of the object. Further, the three-dimensional structure of the object can be accurately obtained by comparing the multi-order diffraction signals with a database. As such, the present disclosure can be used in measuring dimensions such as the line width, the height and the sidewall angle of an object.

As such, aforementioned embodiments of the present disclosure may increase the accuracy in measuring nanoscale three-dimensional structures. Therefore, embodiments of the present disclosure can be used in measuring dimensions such as the height, the sidewall angle and the gate length of a FinFET structure, and facilitate the rapid development of EUV (extreme ultraviolet) lithography processing technologies.

The above-described descriptions of the detailed embodiments are only to illustrate the preferred implementation according to the present disclosure, and it is not intended to limit the scope of the present disclosure. Accordingly, all modifications and variations completed by those with ordinary skill in the art should fall within the scope of the present disclosure defined by the appended claims.

What is claimed is:

1. A scattering measurement system, comprising:
a light source generator configured to generate a detection light beam with multi-wavelengths, wherein the detection light beam is incident on an object so as to generate a plurality of multi-order diffraction light beams with three-dimensional feature information;
a spatial filter configured to filter out zero-order light beams from the plurality of multi-order diffraction light beams; and
a detector having a photosensitive array and configured to receive and convert the plurality of multi-order diffraction light beams filtered out by the spatial filter into multi-order diffraction signals with the three-dimensional feature information.

2. The scattering measurement system of claim 1, wherein the multi-wavelengths of the detection light beam are discontinuous.

3. The scattering measurement system of claim 1, wherein the spatial filter includes a low transmission filter, and the zero-order light beams are filtered out by the low transmission filter of the spatial filter.

4. The scattering measurement system of claim 1, further comprising a database stored with a plurality of multi-order diffraction feature patterns.

5. The scattering measurement system of claim 4, further comprising a comparison unit configured to compare the multi-order diffraction signals with the plurality of multi-order diffraction feature patterns in the database so as to obtain a three-dimensional structure of the object corresponding to the multi-order diffraction signals.

6. The scattering measurement system of claim 4, wherein the plurality of multi-order diffraction feature patterns are multi-order diffraction feature patterns of different wavelengths.

7. The scattering measurement system of claim 6, wherein the plurality of multi-order diffraction feature patterns are established based on a rigorous coupled-wave theory.

8. A scattering measurement method, comprising:
emitting a detection light beam with multi-wavelengths onto an object so as to generate a plurality of multi-order diffraction light beams with three-dimensional feature information;
filtering out, by a spatial filter, zero-order light beams from the plurality of multi-order diffraction light beams;
receiving, by a photosensitive array, the plurality of multi-order diffraction light beams with the zero-order light beams filtered out; and
converting, by the photosensitive array, the received plurality of multi-order diffraction light beams into multi-order diffraction signals with the three-dimensional feature information.

9. The scattering measurement method of claim 8, wherein the multi-wavelengths of the detection light beam are discontinuous.

10. The scattering measurement method of claim 8, further comprising comparing the multi-order diffraction signals with a plurality of multi-order diffraction feature patterns so as to obtain a three-dimensional structure of the object corresponding to the multi-order diffraction signals.

11. The scattering measurement method of claim 10, wherein the plurality of multi-order diffraction feature patterns are established based on a rigorous coupled-wave theory.

12. The scattering measurement method of claim 11, wherein the plurality of multi-order diffraction feature patterns are multi-order diffraction feature patterns of different wavelengths.

13. The scattering measurement method of claim 12, wherein the plurality of multi-order diffraction feature patterns are selected from a database.

14. The scattering measurement method of claim 13, wherein the database collects and stores the multi-order diffraction feature patterns of different wavelengths.
